(19) United States
(12) Patent Application Publication
(10) Pub. No.: US 2008/0227647 A1
(43) Pub. Date: Sep. 18, 2008

(54) Current lead with high temperature superconductor for superconducting magnets in a cryostat

(76) Inventors: Concetta Beneduce, Zuerich (CH); Andreas Kraus, Riedikon (CH); Michael Bauernschmitt, Wetzikon (CH)

Correspondence Address: KOHLER SCHMID MOEBUS, RUPPMANNSTRASSE 27, D-70565 STUTTGART, DE

(21) Appl. No.: 12/076,094

(22) Filed: Mar. 13, 2008

(30) Foreign Application Priority Data
Mar. 16, 2007 (DE) 10 2007 013 350.4

(51) Int. Cl. H01F 6/04; F25B 19/00

(52) U.S. Cl. 505/163; 505/898; 62/51.1

(57) ABSTRACT

A cryostat assembly (1) for a superconducting magnet assembly, with a helium tank (2) for liquid helium, whereby the superconducting magnet assembly (6) is located in the helium tank (2), with a nitrogen tank (3) for liquid nitrogen, whereby the nitrogen tank (3) encloses the helium tank (2), and with at least one access tube (4) in which the current lead is mounted through which current can be lead from the room-temperature warm area of the cryostat (1) into the superconducting magnet assembly (6), whereby the current lead assembly comprises at least one current lead with a normal conductor part (13) and a superconductor part (14) made of HTS material, characterized in that a terminal (12) of the at least one current lead, through which the normal conductor part (13) is electrically connected with the superconductor part (14) is thermally coupled with a wall of the nitrogen tank (3). This ensures an efficient cooling of the transition from the HTS to the normal conductor in the current lead in a simple and cost-effective way.

This application claims Paris Convention priority of DE 10 2007 013 350.4 filed Mar. 16, 2007 the complete disclosure of which is hereby incorporated by reference.

### BACKGROUND OF THE INVENTION

The invention relates to a cryostat assembly for a superconducting magnet assembly with a helium tank for liquid helium, whereby the superconductive magnet assembly is located in the helium tank, with a nitrogen tank for liquid nitrogen, whereby the nitrogen tank encloses the helium tank, and with at least one access tube in which a current lead assembly is mounted through which current can be led from the room-temperature warm area of the cryostat into the superconductive magnet assembly, whereby the current lead assembly comprises at least one current lead with a normal conductor part and a superconductor part made of high-temperature superconductor (=HTS) material.

Current lead assemblies with normal conductor parts and superconductor parts made of HTS material for charging superconductive magnet assemblies in cryostats have become known e.g. by J. R. Hull, IEEE Transactions on applied superconductivity, Vol. 3, No. 1, March 1993, pages 869-875.

Cryostat assemblies as specified above are, for example, used for measurements with nuclear magnetic resonance (NMR) or electron spin resonance (ESR) or for laboratory magnets. The superconducting magnet assemblies contained therein generate strong magnetic fields, whereby stable, low temperatures have to prevail to reach the superconducting state, as can be ensured with such a cryostat assembly.

The superconducting magnet assembly (magnet coil system) is located in a first cryo container with a cryogen liquid, typically liquid helium, which is surrounded by radiation shields, super thermal insulation blankets and another cryo container with a cryogen liquid, typically liquid nitrogen. The liquid containers, radiation shields and super thermal insulation blankets are located in an outer container, which limits a vacuum chamber (=outer vacuum shell, outer sheath). The superconductive magnet is cooled by the volatile helium surrounding it and kept at a constant temperature. The elements surrounding the helium container serve for the thermal insulation of the helium container so that the incidence of heat into the helium container is minimized and the helium evaporation rate remains small.

The helium container is usually connected to the outer vacuum shell via at least two thin-walled suspension tubes. The container is thus fixed mechanically and the suspension tubes also provide access to the magnet as required, for example, for charging. Moreover, the lost gas is discharged via the suspension tubes, whereby the suspension tubes are cooled in turn and—in the ideal case—the heat input is completely compensated via the tube wall. Such a system is described, for example, in DE 29 06 060 A1 (corresponds to GB 2 015716) and in the publication “Superconducting NMR Magnet Design (Concepts in Magnetic Resonance, 1993, 6, 255-273)”.

The superconducting magnets are typically charged via a current lead, which is either permanently mounted or inserted into one of the suspension tubes via a plug-in connection. The current lead provides the connection between the magnet, at a low temperature, and the power supply unit at room temperature.

One type of such current leads consists of copper or brass leads the cross-section of which is optimized for a given length and magnet current and which are cooled via the escaping helium gas. Without any current flowing, such a lead reaches a minimum heat input in the region of 1 mW/A of the design current. In the case of frequent charging and discharging processes of the superconducting magnet, the heat input additionally increases because of the Joule heat generated in the lead.

An option for considerably decreasing the heat input into the helium container is the utilization of a two-part current lead, the lower part from the temperature of the helium bath (approx. 4K) up to a temperature between 20K and 90K composed of an HTS conductor and the upper part up to room temperature via an exhaust-gas-cooled copper or brass lead. The use of the HTS allows carrying high electrical currents at—compared to copper/brass—low heat conductivities and small cross-sectional areas. Since the current in the superconductor can flow without any loss, the heat input into the helium bath is virtually independent of the current and only determined by the heat conduction in the superconductor. The capacity to transport high electrical currents without any loss, in combination with low thermal conductivity, leads to a reduction of the He losses and thus the operating costs. There are many articles concerning the design of the HTS current leads, in particular J. R. Hull, IEEE Transactions on Applied Superconductivity, 1993, 3, 869-875; R. Wesche and A. M. Fuchs, Cryogenics, 1994, 34, 145-154.

HTS and copper leads are connected with an adaptor via soft-soldering. In particular when charging the superconducting magnet, a large amount of Joule heat is generated in the metallic part of the current lead, which would heat up the upper part of the HTS above its critical temperature. The transition from the HTS to the normal conductor is therefore additionally cooled in order to keep the temperature below the critical temperature of the HTS part. This can be achieved with a heat exchanger through which helium gas or liquid nitrogen is pumped. Such an assembly is described in U.S. Pat. No. 5,563,369 or U.S. Pat. No. 5,166,776, for example. A further option is to actively cool the transition by coupling to a cold stage of a cryo cooler. Such an assembly is described in EP 870,307 (corresponds to U.S. Pat. No. 5,742,217) or in U.S. Pat. No. 4,895,831 or in U.S. Pat. No. 5,991,647, for example.

The described assemblies have the disadvantage that the cooling has to be provided by additional components or cooling devices which are not required for the normal operation of the cryostat or which even disturb the normal operation. With the additional components or cooling aggregates, the assembly design becomes difficult and expensive.

The task of this invention is to ensure an efficient cooling of the transition from the HTS to the normal conductor in the current lead in a simple and cost-effective way.

### SUMMARY OF THE INVENTION

This task is solved via a cryostat assembly as specified above, characterized in that one terminal of the at least one current lead, through which the normal conductor part is electrically connected with the superconductor part, is thermally coupled with a wall of the nitrogen tank.

According to the invention, the cooling of the at least one terminal at which the normal conductor part and the HTS part of the current lead are connected (e.g. via soft-soldering) is provided with the help of a thermal coupling to the nitrogen container located in the cryostat. This container is independent of the current lead part of the cryostat assembly.

The transition from the metallic conductor to the HTS conductor is coupled with a preferably detachable and thermally highly conductive connection to the nitrogen container, the connection simultaneously ensuring galvanic isolation. The temperature of the nitrogen tank of approximately 77 K allows for operating the transition from the normal conductor to the HTS conductor in the temperature range between 81 and 90 K. The advantage of the assembly is also that a simple suspension tube of the helium container can be used for holding the current lead with few modifications.

The thermal coupling is typically achieved via a mechanical connection of the terminal to the nitrogen tank, in particular via contact elements, contacting elements, etc. made of well heat-conducting material, preferably copper, aluminum and/or aluminum nitride. A material can usually be regarded as being properly heat-conducting when the heat conductivity is at least 20 W/(K*m), preferably at least 100 W/(K*m), each measured at room temperature.

Preferred versions of the invention result from the dependent patent claims.

A variant of the cryostat assembly according to the invention provides that a properly heat-conducting element, e.g. a heat-conducting plate made of aluminum, is mounted in the N₂-container. If this element connects cover and base of the container, the temperature gradient from base to cover remains small even at a low LN₂-level. This thermal short-circuit thus permits keeping the temperature of the transition between the normal conductor and the HTS conductor at a lower value independently of the LN₂-level, even if the contact element is thermally coupled with the cover of the nitrogen tank (i.e. the connection of the terminal to the cover of the nitrogen tank is established). Within the framework of the invention it is nevertheless sufficient when the heat-conducting plate is submerged in the liquid nitrogen.

The HTS part preferably consists of tapes. At the maximum operating temperature of the transition from the normal conductor to the HTS conductor, the critical current I_{c} of a single HTS tape is very low. For a given magnet current more tapes have to be used to guarantee that the current flows without any loss. Tapes of the same polarity are soldered together to form a comparatively rugged and compact conductor (stack).

In a preferred version, a multifilament Bi₂Sr₂Ca₂Cu₃Oₓ tape is used with a critical temperature T_{c} of 110 K.

In a further advantageous version, another HTS is used with a critical temperature>90 K, e.g. YBa₂Cu₃Oₓ (T_{c}=93 K) or Bi₂Sr₂CaCu₂Oₓ (T_{c}=95 K).

A preferred version of the invention provides that several individual and galvanically isolated leads (current leads) for different current loads (e.g. coil sections of the magnet assembly) are integrated in one single current lead to be able to charge different superconductive coils of the magnet assembly separately. Towards this end, the warm end of the HTS part as well as the cold end of the metallic part of the lead is soldered with a terminal made of a properly conducting metal, e.g. pure copper. The terminals of the different leads are insulated with respect to each other and with respect to the cryostat assembly and connected with a metallic contact piece (inner contact element) via an electrically isolating material having good heat-conduction. This material is preferably made of aluminum nitride. In a preferred version, the aluminum nitride is coated with a solderable metal layer and connected with the terminal and the contact piece via soldering.

In a further preferred version, each terminal has an electrically insulating coating having good heat-conduction. This coating is preferably made of a diamond-like carbon coating (DLC). The terminal of this version is preferably cone-shaped and pressed into a cone-shaped bore of the contact piece (inner contact element), which provides for an electrically isolated connection with good heat-conduction.

In an advantageous version of this invention, the contact piece (inner contact element) is cone-shaped and pressed into an outer copper part (outer contact element) when mounting the cryostat assembly. Due to the high surface pressure, this connection ensures excellent heat transfer, it can be easily disconnected again and is very compact. The contact piece (inner contact element) allows for discharge of volatile helium gas from the helium container through openings and thus a helium gas cooling of the current lead along its entire length. The outer copper part (outer contact element) is connected with the nitrogen container in the vacuum via a metal having good thermal conduction. This assembly according to the invention results in a heat resistance of less than 0.5 K/W between the terminals and the nitrogen container.

It is also possible to use such a compact contact connection if the terminals are not cooled via a coupling to the nitrogen container rather with a different cold source, e.g. a cryo cooler. This would be of interest for cryogen-free magnet systems but in particular also for magnet systems in which the magnet is still cooled with LHe (as e.g. described in US 2002 002 830) and the current lead is mounted in a suspension tube of the helium container.

The current lead according to the invention achieves a minimum heat input, without current flow, which is 3 to 4 times smaller than the heat input of a metallic current lead.

The assembly according to the invention allows for operation of the current lead up to a current of approximately 150 A with helium losses comparable to the currentless state. Due to the good heat contact to the nitrogen container, only the nitrogen losses steadily increase with increasing current in the current lead. The maximum current in the current lead is limited by the critical current of the HTS conductor at the temperature reached and at the magnetic field at the location of the terminals.

In particular for charging currents higher than 150 A in the current lead, the cooling at the terminals can be increased. In a further advantageous version, the temperature of the transition metal—HTS is monitored, e.g. with a temperature sensor. The monitoring or a control can be implemented in the power supply unit. If the temperature exceeds an upper threshold, a heater in the helium container is activated in order to produce an additional low helium loss. The additional helium loss results in improved cooling of the current lead due to flowing cold helium vapor. The heater is deactivated as soon as the temperature falls below a lower threshold.

Further advantages of the invention arise from the description and the drawings. Additionally, the characteristics stated above and below can be used separately or in any combination. The versions shown and described are not exhaustive but are simply examples for describing the invention.

The invention is represented in the drawing and is described in detail by means of embodiments.

### BRIEF DESCRIPTION OF THE DRAWING

FIG. 1 shows a schematic cross-section through a cryostat assembly according to the invention;

FIG. 2 shows a schematic representation of the access tube of the cryostat assembly according to the invention;

FIG. 3 shows a schematic representation of the area around the terminals of the cryostat assembly according to the invention;

FIG. 4 shows a schematic cross-section through the inner contact element of the cryostat assembly according to the invention.

### DESCRIPTION OF THE PREFERRED EMBODIMENT

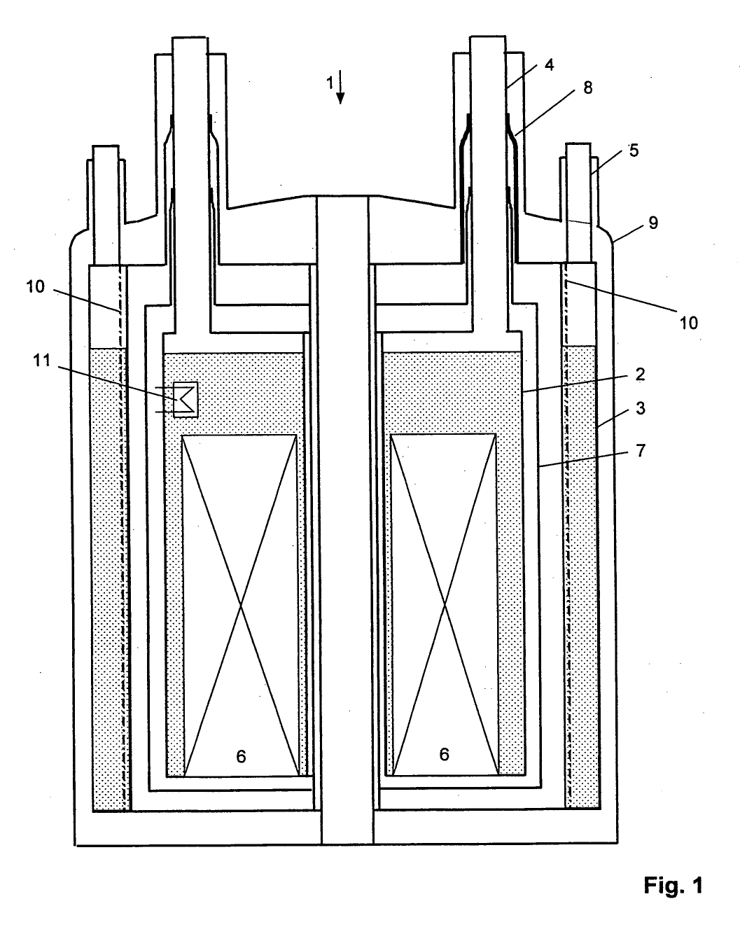

FIG. 1 shows a cryostat assembly with an inner and an outer liquid tank and a superconducting magnet coil as well as two suspension tubes.

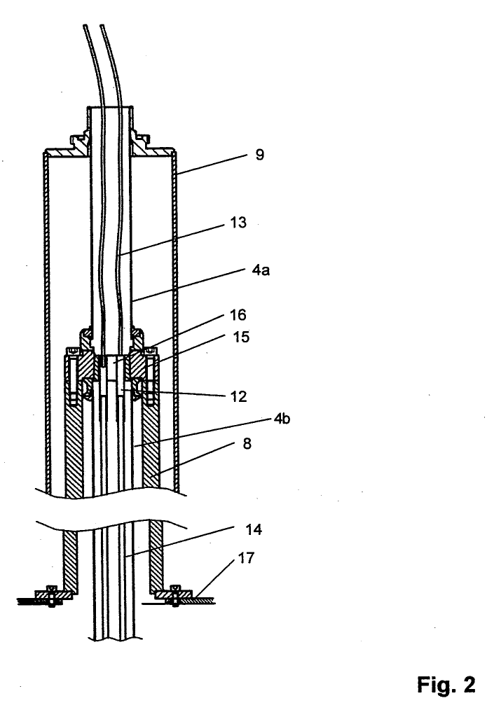

FIG. 1 shows a schematic representation of a cryostat 1 with a magnet assembly 6. The cryostat 1 comprises a liquid tank (helium tank) 2 filled with helium, which is connected with an outer sheath 9 of the cryostat 1 at the suspension tubes 4 and in which a superconductive magnet assembly 6 is held. The suspension tubes 4 are at the same time access tubes 4 for current lead assemblies (see FIG. 2) for the magnet assembly 6. A further liquid tank (nitrogen tank) 3 is arranged around the liquid tank 2, which contains nitrogen at approximately 77 K and which is connected to the outer sheath 9 of the cryostat 1 at the suspension tubes 5. The liquid tank 3 with nitrogen is thermally contacted with the suspension tubes (access tubes) 4. A radiation shield 7 is located between the two liquid tanks 2 and 3, which is, in turn, thermally contacted with the suspension tubes 4. A heating resistance (heating device) 11 is mounted in the liquid tank 2. The liquid tank (nitrogen tank) 3 contains a heat conducting element 10 which is soldered with the cover of the nitrogen tank.

FIG. 2 shows a representation of the current lead tower with the current lead inserted.

According to the invention, a current lead is inserted in at least one of the suspension tubes (access tubes) 4. The current lead comprises a metallic part 13 with several (shown here: two) galvanically isolated leads (from room temperature up to terminal 12) and an HTS part 14 (from terminal 12 up to liquid tank 2) with galvanically isolated tapes or stacks. The connection of the metallic part 13 with the HTS part 14 is established via the terminals 12 which are soldered with the two leads 13, 14. The terminals 12 are arranged within an inner contact cone (inner contact element) 16. The inner contact cone 16 lies form-fit within an outer contact cone (outer contact element) 15 which in turn is screwed or flanged with an element 8 having good heat-conduction, e.g. (here) a contacting tube or highly conductive strands made of pure copper. The contacting element 8 is connected with the cold surface 17 of the liquid tank (nitrogen tank).

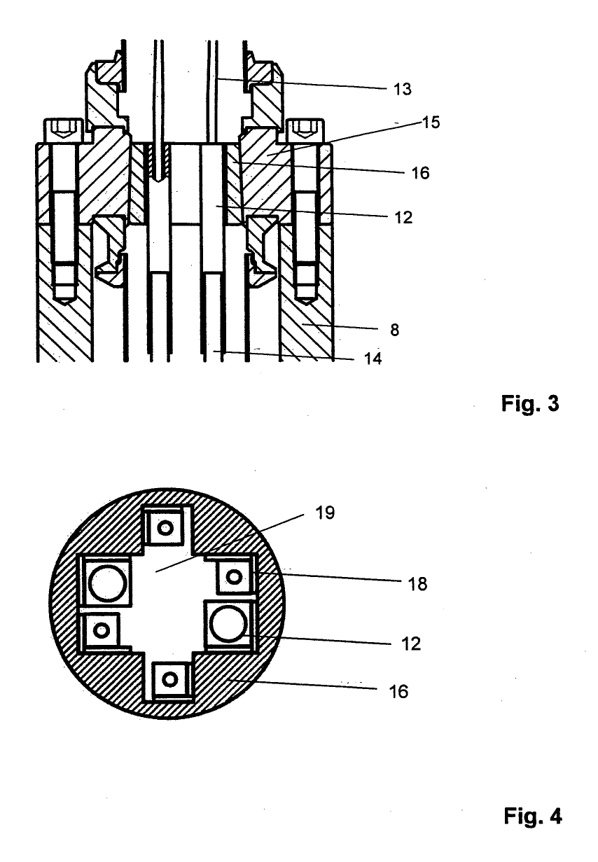

FIG. 3 shows a preferred assembly of the inner 16 and outer 15 contact cone. When mounting the current lead, the inner cone 16 is pressed against the outer cone 15 with a high surface pressure. The cone angle lies between 1 and 5°. Due to this assembly according to the invention, it is possible to establish a detachable connection with a high surface pressure and a good heat transfer with little mounting effort. The detachable connection facilitates access, e.g. for repairs.

FIG. 4 shows a representation of a contact assembly according to the invention.

FIG. 4 shows a preferred assembly of (shown here) e.g. six separate terminals 12 within the inner contact cone (inner contact element) 16. There are thin aluminum nitride plates (contact plates) 18 soldered between terminals 12 and cone 16. The aluminum nitride ensures the galvanic isolation and at the same time high heat conductivity. The metallic leads are soldered in corresponding bores of the terminals 12. In the version shown, two adjacent side surfaces of each terminal 12 are connected to the inner contact element 16 in a corner of the breakthrough opening 19 via contact elements 18 made of aluminum nitride.

This version allows for the compact assembly of different and galvanically isolated leads within a standard suspension tube having an internal diameter of (here) e.g. 29 mm. The open arrangement of the terminals provides a sufficient opening (breakthrough opening) 19 for allowing the helium evaporating from the liquid tank 2 to pass through. This permits helium gas cooling over the entire length of the current lead.

In summary, the invention describes a current lead assembly within a cryostat assembly with which electrical current can be lead from room temperature into a superconductive magnet assembly. The current lead consists of a metallic part and a part with HTS, mounted within a suspension tube. The assembly connects the galvanically isolated terminals to the nitrogen container between the metallic part and the HTS tapes of the current lead via a detachable cone-shaped form-fit connection via an inner and an outer contact cone.

### LIST OF REFERENCE NUMBERS

1 Cryostat
2 Helium tank
3 Nitrogen tank
4, 5 Suspension tubes
4a, 4b Sections suspension tube 4
6 Superconducting magnet assembly
7 Radiation shield
8 Contacting element
9 Outer sheath of the cryostat
10 Heat conducting element
11 Heater
12 Terminal
13 Metallic current leads
14 HTS tapes or stacks
15 Outer contact cone
16 Inner contact cone
17 Wall of the nitrogen container
18 Insulation plate
19 Breakthrough opening

We claim:

1. A cryostat assembly for a superconducting magnet, the cryostat assembly comprising:
a helium tank for liquid helium, the superconducting magnet being disposed in said helium tank;
a nitrogen tank for liquid nitrogen, the nitrogen tank enclosing said helium tank;
at least one access tube through which current is fed from a room-temperature warm area of the cryostat to the superconducting magnet assembly;
at least one current lead having a normal conductor part and a superconductor part made of HTS material, said at least one current lead extending within said at least one access tube; and
a terminal disposed between and electrically connecting said normal conductor part to said the superconductor part, wherein said terminal is thermally coupled to a wall of said nitrogen tank.

2. The cryostat assembly of claim 1, wherein said terminal is fixed to an inner contact element, said inner contact element being detachably fixed to an outer contact element, wherein said outer contact element is thermally coupled with said wall of said nitrogen tank.

3. The cryostat assembly of claim 2, wherein said inner contact element has a cone-shaped outer surface and said outer contact element has a cone-shaped inner surface, wherein said cone-shaped outer surface and said cone-shaped inner surface abut in a form-fit way or abut with said inner contact element being pressed into said outer contact element.

4. The cryostat assembly of claim 2, wherein said outer contact element is fixed to said nitrogen tank via a contacting element or tube having good heat-conduction, a highly conductive strand assembly made of pure copper, or via a flange connection.

5. The cryostat assembly of claim 2, wherein two opposing sections of said access tube are fixed to said outer contact element.

6. The cryostat assembly of claim 2, wherein said inner contact element has a breakthrough opening.

7. The cryostat assembly of claim 6, wherein said breakthrough opening is formed in such a way that helium gas evaporating from said helium tank streams through said breakthrough opening to cool said current lead over an entire length thereof.

8. The cryostat assembly of claim 2, wherein said terminal is fixed or soldered to said inner cone element via at least one contact plate, said at least one contact plate consisting of an electrically insulating material with high heat conductivity.

9. The cryostat assembly of claim 8, wherein said at least one contact plate consists of aluminum nitride.

10. The cryostat assembly of claim 9, wherein said contact plate has a metal coating on both sides for soldering with soft solder.

11. The cryostat assembly of claim 8, wherein said terminal has a rectangular or square cross-section, each contact plate being fixed to two adjacent side surfaces of said terminal, wherein two adjacent contact plates of said terminal are fixed or soldered in a corner of a breakthrough opening of said inner contact, wherein side surfaces of said terminal not provided with contact plates are distanced from said inner contact element.

12. The cryostat assembly of claim 2, wherein said terminal is cone-shaped and pressed in a corresponding cone-shaped bore of said inner contact element.

13. The cryostat assembly of claim 2, wherein said terminal has a coating which is electrically insulating and has good heat-conduction or a coating consisting of a diamond-like carbon coating (=DLC).

14. The cryostat assembly of claim 2, wherein said current lead has several galvanically isolated current leads and therefore several terminals being fixed to said inner contact element.

15. The cryostat assembly of claim 1, wherein said superconductor part comprises Bi₂Sr₂Ca₂Cu₃Oₓ tapes.

16. The cryostat assembly of claim 1, wherein said superconductor part has a critical temperature T_{c}>90 K, contains YBa₂Cu₃Oₓ, or contains Bi₂Sr₂CaCu₂Oₓ.

17. The cryostat assembly of claim 1, wherein an element having good heat-conduction is provided in said nitrogen tank.

18. The cryostat assembly of claim 17, wherein said good heat-conducting element comprises a heat-conducting plate or a plate made of aluminum.

19. The cryostat assembly of claim 1, wherein a temperature sensor for monitoring a temperature of the terminal is provided and a heating device is disposed in said helium tank, with control equipment being provided to activate said heating device when a limit temperature at said terminal is exceeded.
